(19) United States
(12) Patent Application Publication
(10) Pub. No.: US 2016/0068966 A1
(43) Pub. Date: Mar. 10, 2016

(54) LASER CLADDING ALLOY FOR ALUMINUM INJECTION MOLDS

(71) Applicant: GM Global Technology Operations LLC, Detroit, MI (US)

(72) Inventors: Julien P. Mourou, BLOOMFIELD HILLS, MI (US); BRIAN J. PARENT, WINDSOR (CA); JAMES E. OSBOURN, WASHINGTON, MI (US)

(21) Appl. No.: 14/478,014

(22) Filed: Sep. 5, 2014

(51) Int. Cl. C23C 26/02; B32B 15/01

(52) U.S. Cl. CPC C23C 26/02; B32B 15/017

(57) ABSTRACT

A number of variations may include a product that may include a substrate that may include an aluminum alloy and at least one surface and a coating that may include a metallic material deposited over the at least one surface via laser cladding.

### TECHNICAL FIELD

The field to which the disclosure generally relates includes laser cladding of aluminum substrates.

### BACKGROUND

Injection molding processes traditionally use tooling and dies having high hardness, particularly in the casting of plastics and composites.

### SUMMARY OF SELECT ILLUSTRATIVE VARIATIONS

A number of variations may include a product that may include a substrate that may include an aluminum alloy and at least one surface and a coating that may include a metallic material deposited over the at least one surface via laser cladding.

Another variation may include a method that may include providing a substrate that may include an aluminum alloy and a first surface; cladding the substrate with a coating via laser hard facing the substrate wherein the laser hard facing may include: providing a metallic material onto the first surface; providing a laser and applying the focal point of a laser beam on the metallic material; flowing a shielding gas around the laser beam; and melting the metallic material via the laser beam such that a melt pool, the coating, and dilution layer are formed on the first surface.

Another variation may include a method that may include providing an injection molding die that may include a cast Al—Si alloy and a first surface; cladding the substrate with a coating via laser hard facing the substrate wherein the laser hard facing may include providing a metallic material that may include at least copper, nickel, silicon, and boron in a mass ratio of 1:8.9:2.9:1.5 onto the first surface; providing a laser and tracking a laser beam across the metallic material on the first surface of the substrate such that a coating and a dilution layer cover the entire first surface; flowing a shielding gas around the laser beam; and melting the metallic material via the laser beam such that a melt pool, the coating, and dilution layer are formed on the first surface.

Other illustrative variations within the scope of the invention will become apparent from the detailed description provided hereinafter. It should be understood that the detailed description and enumerated variations, while disclosing optional variations, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a method including laser cladding a surface with a coating according to a number of variations.

### DETAILED DESCRIPTION OF ILLUSTRATIVE VARIATIONS

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are considered to be within the scope of the invention.

A number of variations may include hard facing, for example but not limited to, laser hard facing of metallic surfaces alloys that may include depositing a metallic material in powder or wire form and melting the metallic material by use of a laser over the surface of a substrate. The substrate may be coated in the metallic material thereby improving material characteristics such as corrosion resistance, wear resistance, and thermal conductivity. In some instances, the laser and metallic material may traverse the substrate as metallic material is deposited or the substrate may move beneath a stationary laser while metallic material is deposited.

The metallic material coated onto a substrate may be fed via a nozzle or nozzles such that the metallic material meets the substrate at a point where a laser may melt the metallic material, forming a melt pool, which may subsequently harden into a coating on a substrate. The laser and metallic material may be deposited in a controlled fashion such that the substrate may be partially or fully covered by the hard-facing metallic material. In some instances, the metallic material may be deposited onto the substrate prior to melting the metallic material.

The laser, when used to melt the metallic material, may be shielded by a shielding gas flowed around the laser beam. Laser power, laser focal point, hard-facing rate, and metallic material deposition rate may all be varied to achieve desirable material characteristics of the deposited metallic material. In some instances, the hardness of the formed hard face may range from about 400 kg/mm² to about 600 kg/mm².

The substrate may be a die including an aluminum alloy used to injection mold plastics, composites, or fiber reinforced plastics. The substrate may include an Al—Si cast aluminum.

The metallic material may include copper, nickel, boron, carbon, and silicon particles and any combination or sub-combination thereof. The metallic material may also include silicide or carbide layers. In some instances, the mass ratio of the metallic material may be about 1:8.9:9.1:5 for Cu:Ni:Si:B (Copper:Nickel:Silicon:Boron).

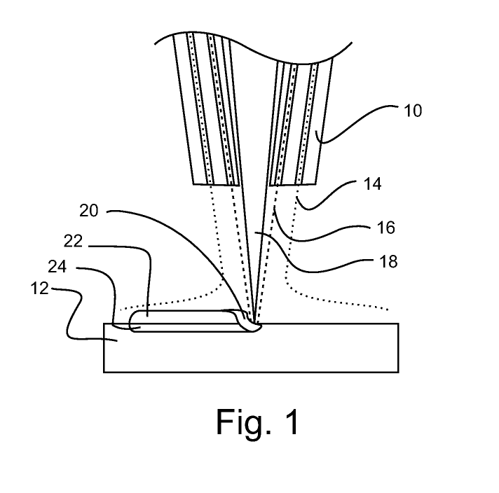

FIG. 1 illustrates a number of variations, which may include a method using a nozzle 10 that may project a laser beam 18 and a metallic material 16 on a substrate 12. In a number of variations the substrate 12 may be an injection molding die. The laser beam 18 and a metallic material 16 may be surrounded by a shielding gas 14 that may also be projected by the nozzle 10. In a number of variations the nozzle 10 may have a center channel though which the laser beam may pass. A first concentric channel may surround the center channel and may be used to deliver powdered metal with a carrier gas. A second concentric channel may surround the first concentric channel and may be used to deliver a shielding gas. The laser beam 18 and a metallic material 16 may meet at the substrate 12 whereby the metallic material 16 is melted into melt pool 20 wherein the metallic material 16 and the substrate 12 form a coating 22 and a dilution layer 24 as the nozzle 10 is tracked across a surface of the substrate 12.

According to variation 1, a product may include a substrate that may include an aluminum alloy and at least one surface and a coating that may include a metallic material deposited over the at least one surface via laser cladding.

Variation 2 may include a product as set forth in variation 1 wherein the metallic material may include at least one of copper, nickel, silicon, boron, a silicide, or a carbide.

Variation 3 may include a product as set forth in variation 1 or 2 wherein the metallic material may include at least one of copper, nickel, silicon, and boron.

Variation 4 may include a product as set forth in any of variations 1 through 3 wherein the metallic material may include at least copper, nickel, silicon, and boron in a mass ratio of 1:8.9:2.9:1.5.

Variation 5 may include a product as set forth in any of variations 1 through 4 wherein the substrate is an injection molding die.

Variation 6 may include a product as set forth in any of variations 1 through 5 wherein the aluminum alloy may include a cast Al-Si alloy.

According to variation 7 a method may include providing a substrate that may include an aluminum alloy and a first surface; cladding the substrate with a coating via laser hard facing the substrate wherein the laser hard facing may include: providing a metallic material onto the first surface; providing a laser and applying the focal point of a laser beam on the metallic material; flowing a shielding gas around the laser beam; and melting the metallic material via the laser beam such that a melt pool, the coating, and dilution layer are formed on the first surface.

Variation 8 may include a method as set forth in variation 7 that may further include tracking the laser beam across the metallic material on the first surface of the substrate such that the resulting coating and dilution layer cover the entire first surface prior to flowing a shielding gas around the laser beam.

Variation 9 may include a method as set forth in any of variations 7 through 8 that may further include tracking the substrate beneath the laser beam such that the resulting coating and dilution layer cover the entire first surface.

Variation 10 may include a method as set forth in any of variations 7 through 9 wherein providing a metallic material onto the first surface may include flowing the metallic material onto the first surface via a metallic material wire feed.

Variation 11 may include a method as set forth in any of variations 7 through 10 wherein providing a metallic material onto the first surface may include flowing the metallic material onto the first surface via a metallic material powder feed.

Variation 12 may include a method as set forth in any of variations 7 through 11 wherein providing a metallic material onto the first surface may include providing a metallic material layer onto the first surface.

Variation 13 may include a method as set forth in any of variations 7 through 12 wherein the metallic material may include at least one of copper, nickel, silicon, boron, a silicide, or a carbide.

Variation 14 may include a method as set forth in any of variations 7 through 13 wherein the metallic material may include at least one of copper, nickel, silicon, and boron.

Variation 15 may include a method as set forth in any of variations 7 through 14 wherein the metallic material may include at least one of copper, nickel, silicon, and boron in a mass ratio of 1:8.9:2.9:1.5.

Variation 16 may include a method as set forth in any of variations 7 through 15 wherein the aluminum alloy may include a cast Al—Si alloy.

Variation 17 may include a method as set forth in any of variations 7 through 16 wherein the substrate is an injection molding die.

Variation 18 may include a method as set forth in any of variations 7 through 17 wherein the substrate is tooling.

Variation 19 may include a method as set forth in any of variations 7 through 18 wherein the substrate may be a plastic injection molding die.

According to variation 20 a method may include providing an injection molding die that may include a cast Al-Si alloy and a first surface; cladding the substrate with a coating via laser hard facing the substrate wherein the laser hard facing may include: providing a metallic material that may include at least one of copper, nickel, silicon, and boron in a mass ratio of 1:8.9:2.9:1.5 onto the first surface; providing a laser and tracking a laser beam across the metallic material on the first surface of the substrate such that a coating and a dilution layer cover the entire first surface; flowing a shielding gas around the laser beam; and melting the metallic material via the laser beam such that a melt pool, the coating, and dilution layer are formed on the first surface.

The above description of variations of the invention is merely demonstrative in nature and, thus, variations thereof are not to be regarded as a departure from the spirit and scope of the inventions disclosed within this document.

What is claimed is:

1. A product comprising:
a substrate comprising an aluminum alloy and at least one surface; and
a coating comprising a metallic material deposited over the at least one surface via laser cladding.

2. A product as set forth in claim 1, wherein the metallic material comprises at least one of copper, nickel, silicon, boron, a silicide, or a carbide.

3. A product as set forth in claim 1, wherein the metallic material comprises at least one of copper, nickel, silicon, and boron.

4. A product as set forth in claim 3, wherein the metallic material comprises at least copper, nickel, silicon, and boron in a mass ratio of 1:8.9:2.9:1.5.

5. A product as set forth in claim 1, wherein the substrate is an injection molding die.

6. A product as set forth in claim 1, wherein the substrate comprises a cast Al—Si alloy.

7. A method comprising:
providing a substrate comprising an aluminum alloy and a first surface;
cladding the substrate with a coating via laser hard facing the substrate wherein the laser hard facing comprises:
providing a metallic material onto the first surface;
providing a laser and applying the focal point of a laser beam on the metallic material;
flowing a shielding gas around the laser beam; and
melting the metallic material via the laser beam such that a melt pool, the coating, and dilution layer are formed on the first surface.

8. A method as set forth in claim 7, further comprising:
tracking the laser beam across the metallic material on the first surface of the substrate such that the resulting coating and dilution layer cover the entire first surface prior to flowing a shielding gas around the laser beam.

9. A method as set forth in claim 7, further comprising:
tracking the substrate beneath the laser beam such that the resulting coating and dilution layer cover the entire first surface.

10. A method as set forth in claim 7, wherein providing a metallic material onto the first surface comprises flowing the metallic material onto the first surface via a metallic material wire feed.

11. A method as set forth in claim 7, wherein providing a metallic material onto the first surface comprises flowing the metallic material onto the first surface via a metallic material powder feed.

12. A method as set forth in claim 7, wherein providing a metallic material onto the first surface comprises providing a metallic material layer onto the first surface.

13. A method as set forth in claim 7, wherein the metallic material comprises at least one of copper, nickel, silicon, boron, a silicide, or a carbide.

14. A method as set forth in claim 7, wherein the metallic material comprises at least one of copper, nickel, silicon, and boron.

15. A method as set forth in claim 7, wherein the metallic material comprises at least one of copper, nickel, silicon, and boron in a mass ratio of 1:8.9:2.9:1.5.

16. A method as set forth in claim 7, wherein the substrate comprises a cast Al—Si alloy.

17. A method as set forth in claim 7, wherein the substrate is an injection molding die.

18. A method as set forth in claim 7, wherein the substrate is tooling.

19. A method as set forth in claim 7, wherein the coating has a hardness ranging from about 400 kg/mm² to about 600 kg/mm².

20. A method comprising:
providing an injection molding die comprising a cast Al-Si alloy and a first surface;
cladding the substrate with a coating via laser hard facing the substrate wherein the laser hard facing comprises:
providing a metallic material comprising at least one of copper, nickel, silicon, and boron in a mass ratio of 1:8.9:2.9:1.5 onto the first surface;
providing a laser and tracking a laser beam across the metallic material on the first surface of the substrate such that a coating and a dilution layer cover the entire first surface;
flowing a shielding gas around the laser beam; and
melting the metallic material via the laser beam such that a melt pool, the coating, and dilution layer are formed on the first surface wherein the coating has a hardness ranging from about 400 kg/mm² to about 600 kg/mm².
